(19) United States
(12) Patent Application Publication
(10) Pub. No.: US 2020/0298792 A1
(43) Pub. Date: Sep. 24, 2020

(54) ENERGY ABSORBING RESTRAINT SYSTEMS, SUCH AS FOR USE WITH CHILD SEATS

(71) Applicant: Shield Restraint Systems, Inc., Elkhart, IN (US)

(72) Inventor: James Russell Eaton, Carmel, IN (US)

(21) Appl. No.: 16/357,183

(22) Filed: Mar. 18, 2019

(51) Int. Cl. B60R 22/28; B60N 2/28

(52) U.S. Cl. CPC B60R 22/28; B60R 2022/286; B60N 2/2809; B60N 2/2884

(57) ABSTRACT

Energy absorbing restraint systems for use with child seats and other devices are disclosed herein. In some embodiments, an energy absorbing restraint system includes a web slide and a web. The web slide can include first and second web apertures extending therethrough. The web can be threaded (a) through the first web aperture from a first side to a second side of the web slide and (b) back through the second web aperture from the second side to the first side of the web slide. The web is attached to itself with, for example, rip stitching to form a joined portion adjacent the second side of the web slide. When a shock load above a preset level is quickly applied to the web, the web is pulled against the web slide to rupture the rip stitching and absorb the shock load transmitted by the web.

### TECHNICAL FIELD

The present disclosure is generally directed to energy absorbing occupant restraint systems, such as for use in restraining a child seat in an automobile or other vehicle.

### BACKGROUND

Many types of personal restraint systems are used in automobiles, utility task vehicles (UTVs), and other vehicles. Small children, for example, are typically secured in a portable child seat that can be mounted to a passenger seat in an automobile or other vehicle. The child seat can be secured to the passenger seat by attaching one or more straps, belts, etc., (e.g., webs) from the child seat to corresponding anchor points in the vehicle, and then adjusting the tension in the webs to securely hold the child seat in place. During a crash or other significant dynamic event, substantial loads can be applied to the webs as the vehicle rapidly decelerates. The webs can stretch a small amount and absorb some energy during the crash, but the anchor points in the vehicle are generally rigid and offer little energy absorption. As a result, significant shock loads can be partially transmitted to the child seat during a crash.

### BRIEF DESCRIPTION OF THE DRAWINGS

FIGS. 1A and 1B are top and side views, respectively, of a restraint system configured in accordance with embodiments of the present of the technology, and FIG. 1C is an enlarged cross-sectional side view of a portion of the restraint system taken along the line 1C-1C in FIG. 1A.

FIG. 2A is a side view of a child seat secured to a vehicle seat with the restraint system of FIGS. 1A--1C in accordance with embodiments of the present technology, FIG. 2B is an enlarged, partially cross-sectional front view of the child seat and the restraint system taken along the line 2B-2B in FIG. 2A, and FIG. 2C is an enlarged, partially cross-sectional front view of the child seat and the restraint system taken along the line 2C-2C in FIG. 2B.

FIG. 3 is an enlarged, cross-sectional side view of the child seat and restraint system of FIG. 2C when a tension load is applied to the restraint system in accordance with embodiments of the present technology.

### DETAILED DESCRIPTION

The following disclosure describes various embodiments of energy absorbing systems for restraining child seats. For example, some embodiments of the present technology are directed to a restraint system including a web slide having first and second web apertures. A web can be threaded through the web slide such that the web extends (a) through the first web aperture from a first side to a second side of the web slide and (b) back through the second web aperture from the second side to the first side of the web slide. The web can further be folded and attached to itself to form a joined portion adjacent the second side of the web slide. For example, the web can be attached to itself with frangible stitching to form the joined portion of the web. Upon application of a tension load to the web (e.g., during a crash), the joined portion of the web is pulled taught against the web slide, thereby rupturing the frangible stitching and absorbing a portion of the energy transmitted by the web.

In one aspect of the present technology, the restraint system can be used to securely attach a child seat to an anchor point in a vehicle. For example, the web can be coupled to the anchor point, and the web slide can be coupled to the child seat such that the joined portion of the web is adjacent to a front side of a rear wall or panel of the child seat. During a crash or other dynamic event, the joined portion of the web is pulled against the web slide to break the stitching and absorb kinetic energy transmitted by the web to thereby reduce the shock on a child secured in the child seat.

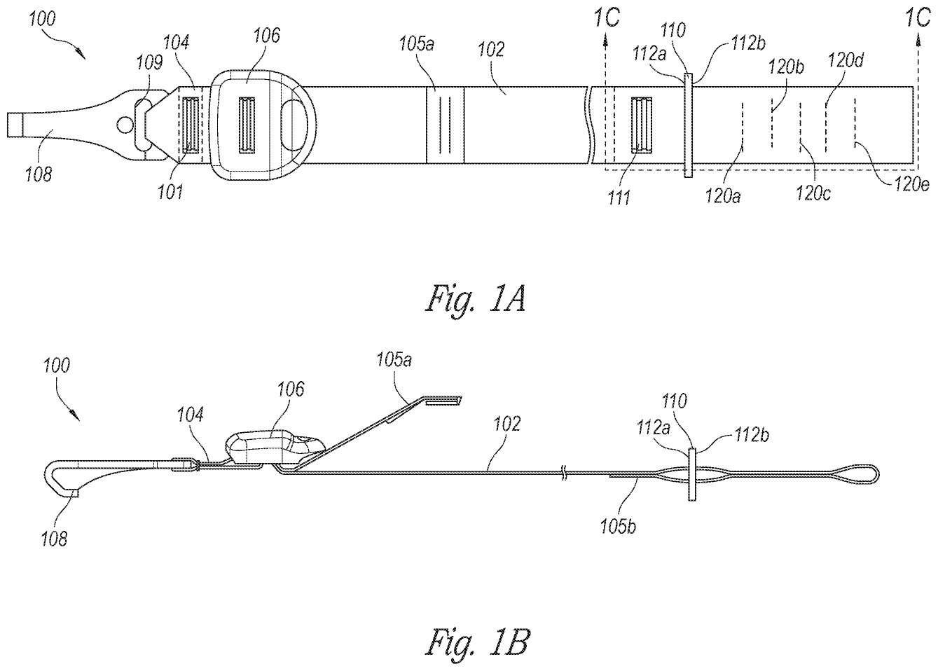

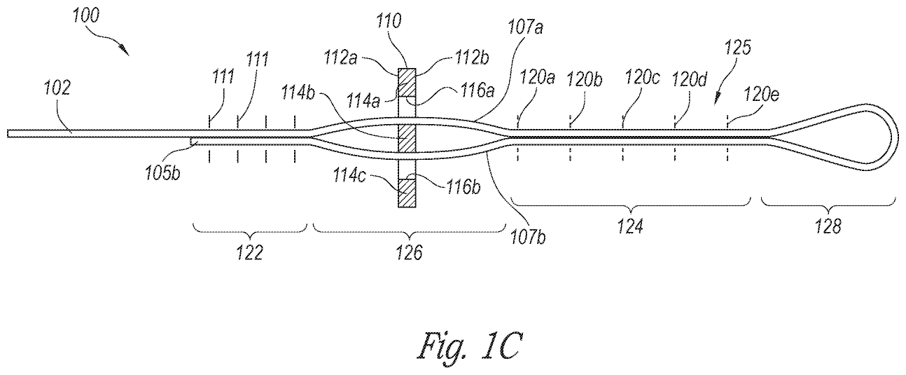

Certain details are set forth in the following description and in FIGS. 1A-3 to provide a thorough understanding of various embodiments of the present technology. In other instances, well-known structures, materials, operations and/or systems often associated with webs, web adjusters, child seats, and other personal restraint system hardware, etc., are not shown or described in detail in the following disclosure to avoid unnecessarily obscuring the description of the various embodiments of the present technology. Those of ordinary skill in the art will recognize, however, that the present technology can be practiced without one or more of the details set forth herein, or with other structures, methods, components, and so forth.

The terminology used below is to be interpreted in its broadest reasonable manner, even though it is being used in conjunction with a detailed description of certain examples of embodiments of the technology. Indeed, certain terms may even be emphasized below; however, any terminology intended to be interpreted in any restricted manner will be overtly and specifically defined as such in this Detailed Description section.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIGS. 1A and 1B are top and side views, respectively, of a restraint system 100 configured in accordance with embodiments of the present of the technology. FIG. 1C is an enlarged cross-sectional side view of a portion of the restraint system 100 taken along the line 1C-1C in FIG. 1A. Referring to FIGS. 1A-1C together, the restraint system 100 includes a first web 102 and a second web 104 coupled together by a web adjuster 106 (e.g., a tilt-lock web adjuster, a push-button web adjuster, etc.) that is operable to adjust the tension in the webs 102, 104. In other embodiments, the web adjuster 106 can be omitted. The webs 102, 104 can be any type of flexible web, strap, seat belt web, etc., well known in the art for use with seat belts, child seats, and/or other restraint systems, and can be constructed of various suitable materials known in the art, such as woven nylon.

In the illustrated embodiment, the first web 102 includes a first end portion 105a and a second end portion 105b. The first end portion 105a extends through the web adjuster 106 and is configured to be grasped and pulled by a user to increase the tension in the webs 102, 104. The second web 104 is coupled to a hook 108 that can be releasably attached to, for example, an anchor point in a vehicle, More specifically, in the illustrated embodiment the second web 104 includes an attachment loop (e.g., a portion of web material that is formed in a loop and stitched to itself by stitching 101) that extends through a web aperture 109 in the hook 108 to couple the second web 104 to the hook 108.

In the illustrated embodiment, the restraint system 100 includes a web slide 110 (e.g., a three-bar slide) having a first side 112a, a second side 112b opposite the first side 112a, a first web aperture 116a (e.g., a generally rectangular opening) extending through the web slide 110 between the sides 112a, b, and a second web aperture 116b (e.g., a generally rectangular opening) extending through the web slide 110 between the sides 112a, b. More specifically, the web apertures 116 are formed between pairs of adjacent crossmembers 114 (identified individually in FIG. 1C as first through third crossmembers 114a-114c, respectively). In other embodiments, the web apertures 116a, b can have circular, square, polygonal, irregular, or other shapes, and/or can be positioned differently on the web slide 110. The web slide 110 can be manufactured using suitable materials and methods known in the art. For example, the web slide 110 can be formed from suitable metal (e.g., steel plate) or composite materials.

As shown in FIG. 1C, the second end portion 105b of the first web 102 can be threaded through (i) through the first web aperture 116a from the first side 112a to the second side 112b of the web slide 110 and (b) back through the second web aperture 116b from the second side 112b to the first side 112 of the web slide 110. As such, a first length 107a of the first web 102 overlays a second length 107b of the first web 102 and forms a loop 125. Additionally, a first portion of the first length 107a is attached to the second length 107b by first stitching 111 (shown exploded in FIG. 1C) to form a first joined portion 122 of the first web 102 that is adjacent to the first side 112a of the web slide 110. Another portion of the length 107a is attached to the second length 107b by second stitching 120 (shown exploded in FIG. 1C; identified individually as first through fifth rows/lines of second stitching 120a-120e) to form a second joined portion 124 of the first web 102 that is adjacent to the second side 112b of the web slide 110. In the illustrated embodiment, each of the crossmembers 114 is oriented generally parallel to the rows of second stitching 120 as shown in FIG. 1A, and the rows of second stitching 120 are generally spaced equally apart. The first web 102 further includes a first looped portion 126 between the joined portions 122 and 124 and a second looped portion 128 adjacent to the second joined portion 124. The first looped portion 126 spans/crosses through the web slide 110 such that the second cross member 114b is positioned between adjacent portions of the first and second lengths 107a, b of the first web 102 within the first looped portion 126.

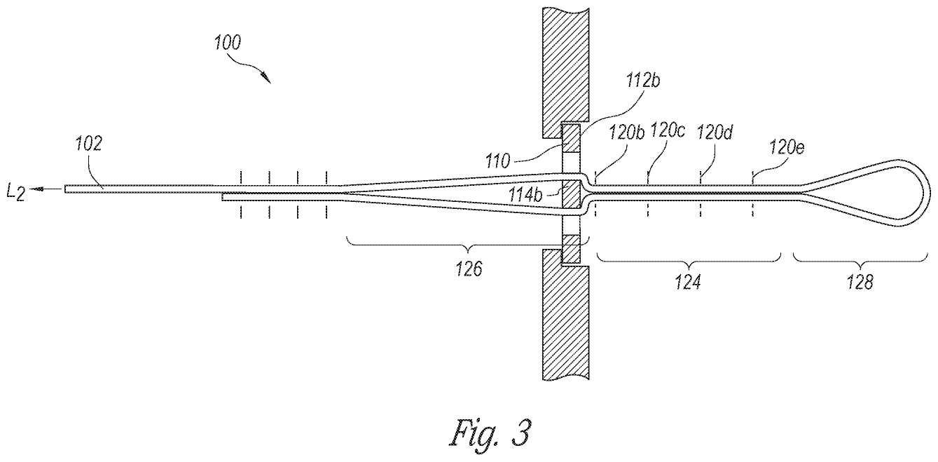

The first stitching 111 is configured to maintain the web attachment at the first joined portion 122 even when a tension load is applied to the first web 102. That is, the first stitching 111 is configured not to break when a tension load is applied to the first web 102. As described in detail below with reference to FIG. 3, the second stitching 120 is configured to rip, break, or otherwise rupture when a shock or tension load is applied to the first web 102 to absorb a portion of the dynamic energy transmitted by the first web 102. For example, in some embodiments the second stitching 120 can comprise frangible (e.g., rip) stitching that is selected to break when a tension load above a preset magnitude is applied to the first web 102. In other embodiments, the first web 102 can be attached to itself in other manners to form the first and second joined portions 122 and 124. For example, one or more clamps, adhesives, etc., can be used to attach the first web 102 to itself to form the joined portions. Likewise, in other embodiments the stitching 111 and 120 can have other suitable arrangements and configurations. For example, the second stitching 120 can include more or less than the illustrated five rows of stitching, and the rows can have different arrangements relative to the web slide 110 (e.g., arranged at angles other than parallel relative to the crossmembers 114). Moreover, the rows of second stitching 120 can have different (e.g., irregular) spacings.

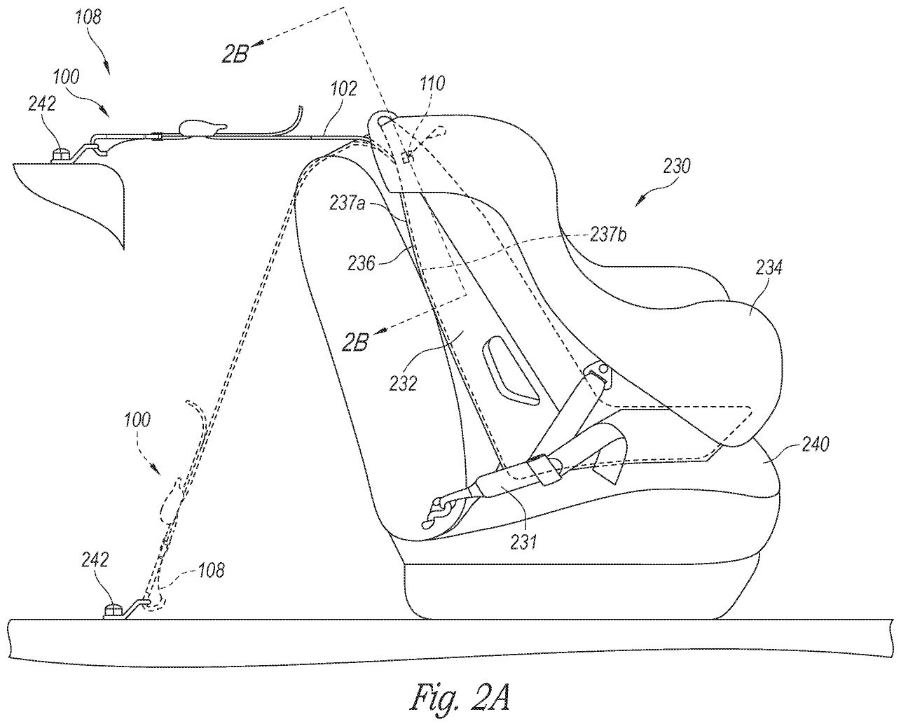

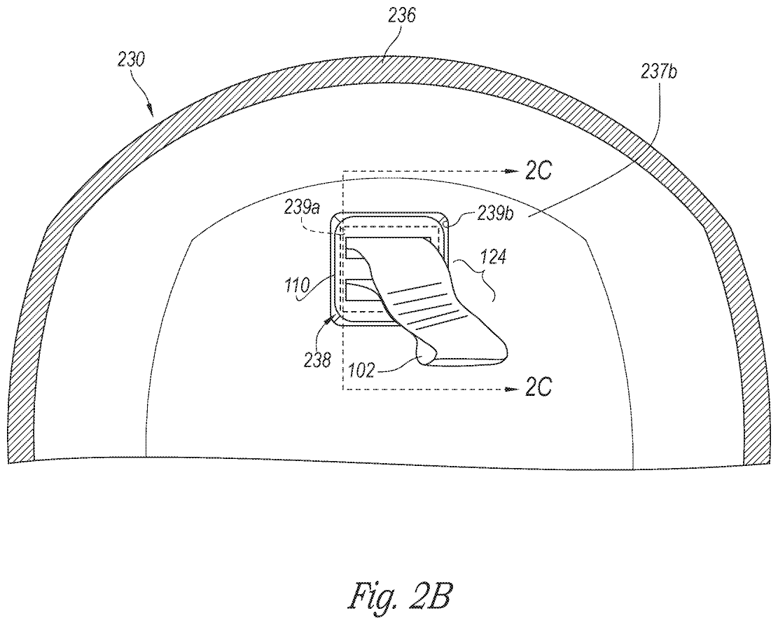

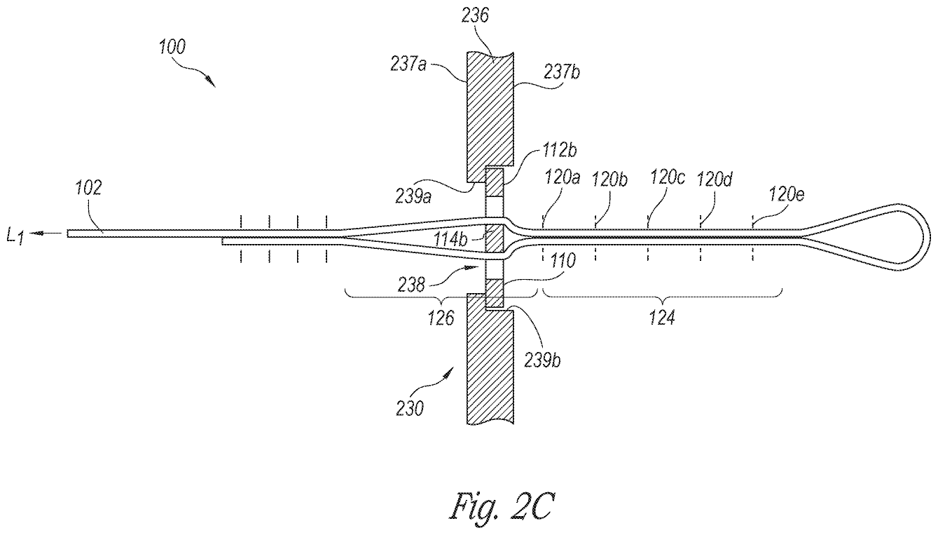

The restraint system 100 can be used to absorb kinetic energy and reduce shock loads in a wide variety of applications. FIG. 2A, for example, is a side view of a child seat 230 secured to a vehicle seat 240 (e.g., a seat within an automobile) with the restraint system 100 of FIGS. 1A-1C in accordance with embodiments of the present technology. The child seat 230 can be one of any of a number of child seats well known to those of ordinary skill in the art, and can include, for example, a shell 232 having a seat cushion 234 thereon. In the illustrated embodiment, the restraint system 100 securely attaches an upper portion of the child seat 230 to an upper anchor 242 (e.g., a bar) in a vehicle. More specifically, the hook 108 can be attached to the upper anchor 242, and the web slide 110 can be engaged with to a rear wall or panel 236 of the seat shell 232 as explained in greater detail below with reference to FIG. 2B. In other embodiments, the hook 108 can be secured to a lower anchor 244 in the vehicle as illustrated in dashed lines in FIG. 2A. A lower portion of the child seat 230 can be secured to the vehicle seat 240 with additional restraints, such as a restraint 231 of a type well known to those of ordinary skill in the art.

FIG. 2B is an enlarged, partially cross-sectional front view of an upper portion of the child seat 230 and the restraint system 100 taken along the line 2B-2B in FIG. 2A, and FIG. 2C is an enlarged, partially cross-sectional front view of the child seat 230 and restraint system 100 taken along the line 2C-2C in FIG. 2B. Referring to FIGS. 2B and 2C together, the rear wall 236 of the shell 232 can include a rear side 237a facing the vehicle seat 240 (FIG. 2A), a front side 237b opposite the rear side 237a and configured to face a child seated in the child seat 230, and an aperture 238 extending through the rear wall 236 between the sides 237a, b. In the illustrated embodiment, the aperture 238 is stepped and includes a flange portion 239a having a smaller cross-sectional area than a recessed portion 239b formed in the front side 237b of the rear wall 236. That is, the flange portion 239a of the aperture 238 can be narrower in height and/or width than the second portion 239b of the aperture 238.

The web slide 110 is positioned in the recessed portion 239b of the aperture 238 such that first web 102 (e.g., the first looped portion 126) extends through/past the rear wall 236 of the shell 232. For example, the web slide 110 can be positioned in the recessed portion 239b of the aperture 238 and against the flange portion 239a to resist being pulled through the flange portion 239a of the aperture 238 in the direction L. In other embodiments, the flange portion 239a of the aperture 238 can be omitted and the web slide 110 can be secured directly against the front side 237b of the rear wall 236 (e.g., not within a recess therein) with, for example, fasteners, adhesives, etc. In one aspect of the present technology, the restraint system 100 extends through only a single aperture formed in the rear wall 236 of the shell 232.

Accordingly, referring to FIGS. 2A-2C together, the second joined portion 124 of the first web 102 is positioned adjacent to the front side 237b of the rear wall 236 of the shell 232 of the child seat 230 when the restraint system 100 is installed onto the child seat 230. As best shown in FIG. 2C, when the tension in the webs 102, 104 is increased (e.g., as indicated by arrow L₁), the web slide 110 is pulled against the rear wall 236 of the shell 232 (e.g., against the flange portion 239a of the aperture 238) and the first web 102 is pulled against the web slide 110. More specifically, the second crossmember 114b of the web slide 110 contacts/engages the first web 102 at or proximate to the second joined portion 124 (e.g., at or proximate to the first row 120a of second stitching 120).

Referring to FIG. 2C, when a sufficient shock or tension load is applied to the first web 102 (as a result of, e.g., a crash or other rapid deceleration of the vehicle that causes the child seat 230 to jolt forward on the vehicle seat 240), the tension force in the first web 102 pulls the first web 102 against the web slide 110 (e.g., against the second crossmember 114b) to at least partially separate the first length 107a of the first web 102 from the second length 107b at the second joined portion 124, to thereby absorb and dissipate the shock energy transmitted by the first web 102. More specifically, the tension force can pull the first web 102 against the web slide 110 to rip or break all or a portion of the second stitching 120.

FIG. 3, for example, is an enlarged, partially cross-sectional side view of the upper portion of the shell 232 of the child seat 230 and restraint system 100 of FIG. 2C after a sufficient tension load (e.g., indicated by arrow L₂) has been applied to the first web 102 to rip or otherwise rupture the first row 120a of the second stitching 120 (FIG. 2C). The rupture of the first row 120a of the second stitching 120 decreases the length of the second joined portion 124 of the first web 102 while correspondingly increasing the length of the first looped portion 126 as shown in FIG. 3. After the rupture of the first row 120a of the second stitching 120, the second crossmember 114b engages the first web 102 at or proximate to the second row 120 of the second stitching 120.

If the applied shock or tension load is great enough, subsequent rows of the second stitching 120 can sequentially rupture in a rapid zipper effect, thereby decreasing the length of the second joined portion 124 and dissipating the energy from the crash. After all the second stitching 120 is ruptured, the second looped portion 128 can be pulled against the web slide 110 and form a single looped portion together with the first looped portion 126 that stops any further extension of the first web 102. The combined rupture of the second stitching 120 and lengthening of the first looped portion 126 can absorb at least a portion of the shock energy during a rapid deceleration event that would otherwise be transmitted to the child seat 230 by the first web 102—thereby reducing the shock exerted on the child in the child seat 230.

In one aspect of the present technology, by arranging the rows of second stitching 120 generally parallel to the second cross member 114b of the web slide, the web slide 110 can apply a consistent force along the rows of second stitching 120 to generally maximize the force each row of the second stitching 120 can absorb before breaking. In another aspect of the present technology, the second crossmember 114b is configured to generally apply a force only to the row of second stitching 120 directly adjacent thereto (e.g., the first row 120a of the second stitching 120 in FIG. 2C, the second row 120b of the second stitching 120 in FIG. 3, etc.).

In some embodiments, the restraint system 100 is configured such that the second stitching 120 ruptures when the force applied to the first web 102 is greater than or equal to a preset value or “design-level load.” For example, the restraint system 100 can be configured such that each of the rows of the second stitching 120 rupture at a design-level load of between about 250-500 lbf, and the number of rows of the second stitching 120 can control the overall design-level load for the restraint system 100. More generally, the shape and size of the rows of second stitching 120, the thread material type and mechanical properties of the thread and/or other components of the restraint system 100, and the shape and size of the second crossmember 114b can be selected to provide a desired amount of rupture and corresponding decrease in the length of the second joined portion 124 at any of a variety of design-level loads. These and other features can be selected and modified to match or correspond to a calculated design-level load.

The foregoing description of embodiments of the technology is not intended to be exhaustive or to limit the disclosed technology to the precise embodiments disclosed. While specific embodiments of, and examples for, the present technology are described herein for illustrative purposes, various equivalent modifications are possible within the scope of the present technology, as those of ordinary skill in the relevant art will recognize. For example, although the restraint systems illustrated in FIGS. 1A-3 are described in the context of restraining a child seat, those of ordinary skill in the art will understand that the restraint systems described herein can be utilized in a wide variety of other applications utilizing webs as restraints or tethers. For example, the restraint systems of the present technology could be advantageously used in fall-arrest harness systems (e.g., employed at a construction site), recreational utility vehicles (RUVs), automobiles, etc. Accordingly, the restraint systems described herein are not limited to use in any particular restraint system, but can be used with a wide-variety of such systems without departing from the present disclosure. Further, various aspects of the technology described herein can be combined to provide yet other embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to”. Words using the singular or plural number also include the plural or singular number respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

From the foregoing, it will be appreciated that specific embodiments of the disclosed technology have been described herein for purposes of illustration, but that various modifications may be made without deviating from the present technology. Certain aspects of the disclosure described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the disclosed technology. Accordingly, the disclosure and associated technology can encompass other embodiments not expressly shown or described herein.

In general, the terms used in the following claims should not be construed to limit the present technology to the specific embodiments disclosed in the specification, unless the above-detailed description explicitly defines such terms. Accordingly, the actual scope of the present technology encompasses the disclosed embodiments and all equivalent ways of practicing or implementing the disclosure under the claims.

I/we claim:

1. A restraint system, comprising:
a web slide including a first side, a second side, and first and second web apertures extending therethrough from the first side to the second side; and
a web extending (a) through the first web aperture from the first side to the second side of the web slide and (b) back through the second web aperture from the second side to the first side of the web slide,
wherein the web is attached to itself to form a joined portion adjacent the second side of the web slide, and
wherein, when a shock load above a preset level is applied to the web, the web is pulled against the web slide to separate at least a portion of the joined portion and absorb energy in the web.

2. The restraint system of claim 1, further comprising stitching attaching the web to itself, wherein at least a portion of the stitching is configured to break when the shock load is applied to the web.

3. The restraint system of claim 2 wherein the stitching includes a plurality of spaced apart rows of stitching.

4. The restraint system of claim 1 wherein the web slide further includes a crossmember between the first and second web apertures, and wherein the joined portion of the web is pulled against the cross member to decrease the length of the joined portion when the tension load is applied to the web.

5. The restraint system of claim 1 wherein the joined portion of the web is a first joined portion, and wherein the web is further attached to itself to form a second joined portion adjacent the first side of the web slide.

6. The restraint system of claim 5, further comprising:
first stitching attaching the web to itself to form the first joined portion_{;} wherein the first stitching is configured to break when the shock load is applied to the web; and
second stitching attaching the web to itself to form the second joined portion.

7. The restraint system of claim 6 wherein the second stitching is configured not to break when the shock load is applied to the web,

8. The restraint system of claim 1 wherein the web is a first web, and further comprising:
a web adjuster coupled to the first web and configured to adjust he tension in the first web;
a second web coupled to the web adjuster; and
a hook coupled to the second web and configured to be attached to an anchor point within a vehicle.

9. A restraint system for use with a child seat including a shell having a rear wall, the restraint system comprising:
a web slide configured to be positioned adjacent an aperture in the rear wall of the shell, wherein a front side of the rear wall of the shell is configured to face a child seated in the child seat, and wherein the web slide includes first and second web apertures extending therethrough; and
a web extending through the first and second apertures and attached to itself to form a joined portion,
wherein the joined portion is adjacent to the front side of the rear wall of the shell, and
wherein, when a shock load above a preset level is applied to the web, the joined portion of the web is pulled against the web slide to decrease a length of the joined portion to absorb kinetic energy in the web.

10. The restraint system of claim 9, further comprising the child seat.

11. The restraint system of claim 9 wherein the web slide is configured to be positioned in a recess in the front side of the rear wall of the shell.

12. The restraint system of claim 9, further comprising stitching attaching the web to itself, wherein the stitching is configured to break when the shock load is applied to the web.

13. The restraint system of claim 9 wherein the web slide includes a first aperture, a second aperture, and a crossmember between the first and second apertures, wherein the restraint system further comprises stitching attaching the web to itself, and wherein the web is pulled against the crossmember to at least partially shear the stitching when the shock load is applied to web.

14. The restraint system of claim 13 wherein the web slide is a three-bar slide.

15. The restraint system of claim 9 wherein the web is coupled to a web adjuster, and wherein the web adjuster is configured to be coupled to an anchor point within a vehicle and to adjust the tension in the web.

16. A restraint system, comprising:
a web slide including first and second web apertures and a crossmember positioned between the first and second web apertures;
a web extending (a) through the first web aperture from a first side of the web slide to a second side of the web slide and (b) back through the second web aperture from the second side to the first side; and
attachment means attaching the web to itself to form a joined portion adjacent the second side of the web slide,
wherein, when a shock load above a preset level is applied to the web, the joined portion of the web is pulled against the crossmember to separate at least a portion of the attachment means and absorb energy in the web.

17. The restraint system of claim 16 wherein the attachment means include stitching, and wherein the web is pulled against the crossmember to at least partially shear the stitching when the shock load is applied to the web.

18. The restraint system of claim 16 wherein the stitching includes a plurality of spaced apart lines of stitching, and wherein the crossmember has a length that is generally parallel to the lines of stitching.

19. The restraint system of claim 16 wherein the web includes first and second end portions, wherein the first end portion is coupled to a web adjuster configured to adjust the tension in the web, and wherein the second end portion is attached to a portion of the web between the first and second end portions and adjacent to the first side of the web slide.

20. The restrain system of claim 16 wherein the web slide is a three-bar slide.
